(19) United States
(12) Patent Application Publication
(10) Pub. No.: US 2009/0133392 A1
(43) Pub. Date: May 28, 2009

(54) VAPORIZER, IN PARTICULAR FOR AN EXHAUST GAS SYSTEM OF A COMBUSTION ENGINE

(76) Inventors: Marco Ranalli, Augsburg (DE); Chirstopher Noller, Keonigsbrunn (DE); William Perrard, Andelu (FR); Frederic Tronel, Asnieres sur Seine (FR)

Correspondence Address: PAMELA A. KACHUR, 950 W 450 S, BLDG. 4, COLUMBUS, IN, 47201, US

(21) Appl. No.: 12/257,423

(22) Filed: Oct. 24, 2008

(30) Foreign Application Priority Data
Oct. 27, 2006 (EP) 07 021 009.1

(51) Int. Cl. F01N 3/00; B05B 1/24

(52) U.S. Cl. 60/320; 392/403

(57) ABSTRACT

A vaporizer, in particular for an exhaust gas system of a combustion engine, having a heating element with a heating portion and a connection portion, and a vaporizing chamber in which the heating portion of the heating element is arranged, the vaporizing chamber having a fluid inlet and a vapor outlet, the vapor outlet being arranged in the vicinity of the junction between the heating portion and the connection portion whereas the fluid inlet is arranged in the vicinity of the free end of the heating portion.

### FIELD OF THE INVENTION

The invention relates to a vaporizer, in particular for an exhaust gas system of a combustion engine.

### BACKGROUND OF THE INVENTION

Vaporizers are known that have a heating element with a heating portion and a connection portion, and a vaporizing chamber in which the heating portion of the heating element is arranged, the vaporizing chamber having a fluid inlet and a vapor outlet.

Such vaporizer can be used to introduce a small amount of fuel, in particular Diesel fuel, in vaporized form into the exhaust gas upstream of a particulate filter, a catalyst or catalytic coating being provided between the vaporizer and the particulate filter. The introduction of the fuel results in an increase of the exhaust gas temperature such that the temperature necessary for complete combustion of soot trapped in the filter is effected. The fuel introduced into the exhaust gas is to be burned catalytically by either a coating on the particulate filter itself or a separate catalytic converter arranged upstream of the filter. In other applications, the vaporizer can be used to introduce other reactants into the exhaust gas in order to initiate or effect a desired reaction.

Contrary to injectors which introduce the reactant in liquid form into the exhaust gas, vaporizers are designed such that at least the majority of the liquid is vaporized before it is introduced into the exhaust gas. Even though it is intended to completely vaporize the fluid, it cannot be prevented that some fluid exits the vaporizer in liquid form. However, the smaller the content of liquid fuel in the vapor, the fewer are the problems associated with the formation of droplets in the exhaust gas, and the better is the uniform distribution of the introduced reactant in the exhaust gas.

In the prior art, all solutions which have proven to operate satisfactorily have used a “standing” glow plug in which the electrical connection of the glow plug was effected on the bottom side and the vaporizing chamber was arranged above the connection portion. The fluid inlet to the vaporizing chamber was on the bottom side of the vaporizing chamber, in the vicinity of the connection portion, and the vapor outlet was arranged on the upper side of the glow plug. During operation, the liquid reactant was introduced into the vaporizing chamber on the bottom side thereof, and the vaporized reactant was taken from the vaporizing chamber on its upper side. As some disadvantages are associated with this design, alternative constructions were tested. However, all alternatives known so far resulted in the risk that reactant in liquid form was introduced into the exhaust gas.

### BRIEF SUMMARY OF THE INVENTION

It is an object of the invention to provide a vaporizer which allows to arrange the heating element in an orientation which is different from a “standing” configuration.

This object is achieved according to the invention with a vaporizer having a heating element with a heating portion and a connection portion, and a vaporizing chamber in which the heating portion of the heating element is arranged, the vaporizing chamber having a fluid inlet and a vapor outlet, the vapor outlet being arranged in the vicinity of the junction between the heating portion and the connecting portion whereas the fluid inlet is arranged in the vicinity of the free end of the heating portion. This design is based on the recognition that the orientation of the heating element can basically be reversed, with the tip of the heating element being lower than the connection portion. Nevertheless, if the fluid inlet and the vapor outlet are suitably arranged at the vaporizing chamber, namely with the fluid inlet being lower than the vapor outlet, it is ensured that the liquid exits from the vaporizing chamber only in the form of vapor, and not in a liquid state. As pointed out above, it cannot be guaranteed that the vapor coming from the vaporizer does not contain a small amount of reactant in liquid form. Accordingly, the term “vapor” as used here is intended to encompass also vapor in which a certain amount of liquid reactant is present.

According to a preferred embodiment, the vapor outlet of the vaporizing chamber communicates with a vapor tube which extends at an angle between about 45° and 90° with respect to the longitudinal axis of the heating element. This allows to arrange the vaporizer outside the tube which is used for guiding the exhaust gas, thereby reducing problems associated with the temperature existing in the exhaust gas guiding tube.

According to the preferred embodiment, the fluid inlet of the vaporizing chamber communicates with a reactant tube which is formed from a heat resistant material. This allows to arrange the vaporizer close to the combustion engine where the exhaust gas temperature is very high.

The length of the connection portion of the heating element is preferably approximately the same as the length of the heating portion. This allows to increase the distance between the vapor outlet and thereby the exhaust gas guiding tube on the one hand and the free end of the connection portion on the other hand so that the temperatures occurring at the free end of the connection portion are lower.

The invention also relates to a unit comprising an exhaust gas guiding tube, a vaporizer as described above and provided with a vapor tube, the vaporizer extending with its connection portion to a cooler area and with its vapor tube into the exhaust gas guiding tube. The advantageous design of the vaporizer according to the invention allows to arrange the portions which are the most heat sensitive, in particular the free end of the connection portion, at a distance from the exhaust gas guiding tube in order to decrease the temperatures to which the free end of the connection portion is exposed.

Preferably, a heat shield is provided through which the connection portion of the vaporizer extends. This design will significantly decrease the temperatures to which the free end of the connection portion is exposed.

Preferably, the vaporizer has a reactant tube which extends through the heat shield. This allows to connect a conventional pipe to the reactant tube at a place where the temperatures occurring are limited, namely behind the heat shield.

Preferably, the longitudinal axis of the heating element is arranged generally in a vertical direction, with the free end of the heating portion being below the connection portion. The term “generally in a vertical direction” is to be understood as allowing a deviation of up to 45° from a vertical direction. It has been found out that such orientation of the longitudinal axis of the heating element with respect to the vertical direction still ensures that only fluid in vaporized form exits from the vaporizing chamber.

Advantageous details of the invention are apparent from the subclaims.

### SHORT DESCRIPTION OF THE DRAWINGS

FIG. 1 shows a schematical cross section through a vaporizer, and

FIG. 2 schematically shows a unit consisting of a vaporizer, an exhaust gas guiding tube and a heat shield.

### DETAILED DESCRIPTION OF A PREFERRED EMBODIMENT

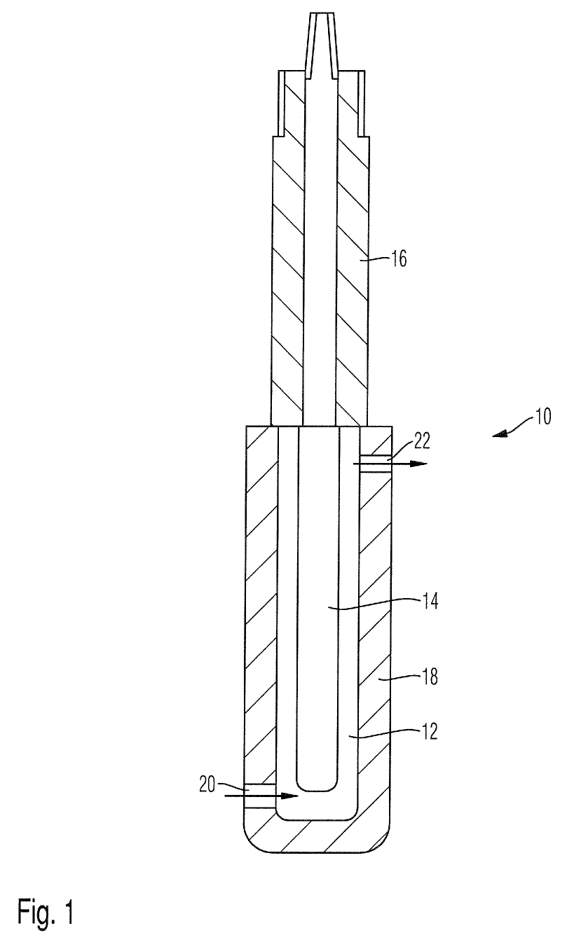

FIG. 1 shows a vaporizer 10 having a heating element and a vaporizing chamber 12. The heating element comprises a heating portion 14 arranged in the interior of vaporizing chamber 12, and a connection portion 16 arranged outside the vaporizing chamber. The heating element can generally be considered as a glow plug. Connection portion 16 serves for mechanically and electrically connecting the heating element, and heating portion 14 serves for transforming the electric power supplied via the connection portion into heat which serves for vaporizing the reactant supplied to vaporizing chamber 12. In the following, it will be assumed that fuel is used as reactant.

Vaporizing chamber 12 is formed in the interior of a housing 18 formed from metal. Housing 18 is provided with two openings, one opening forming a fluid inlet 20 to vaporizing chamber 12, and the other forming a vapor outlet 22 from the vaporizing chamber. Fluid inlet 20 is arranged on the lower side of housing 18 of vaporizing chamber 12 so that it is adjacent the free, lower end of heating portion 14. Vapor outlet 22 is arranged at the upper end of housing 18 of vaporizing chamber 12 so that it is arranged close to the junction between heating portion 14 and connection portion 16.

Fuel supplied via fluid inlet 20 can be heated by means of the energy supplied by heating portion 14, so that it is for its most part vaporized. As the density of the vaporized fuel is lower than that of liquid fuel, it is ensured by means of the location of vapor outlet 22 that the fuel exits vapor chamber 12 only in vaporized form.

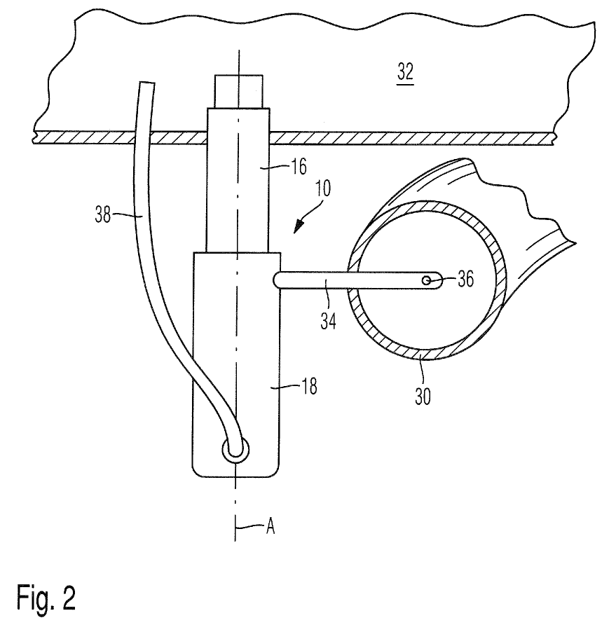

FIG. 2 shows the vaporizer from FIG. 1 installed in a motor compartment of a vehicle. Reference numeral 30 designates an exhaust gas guiding tube which guides exhaust gas from an exhaust manifold of a combustion engine towards a primary catalytic converter or precatalytic converter which is situated close to the combustion engine. Exhaust gas guiding tube 30 could also be just downstream the exhaust gas side of a turbocharger. Due to vaporizer 10 being arranged close to the combustion engine, the temperatures of the exhaust gas can, under certain operating conditions of the combustion engine, be very high.

Arranged close to exhaust gas guiding tube 30 is a heat shield 32 which protects other components arranged in the motor compartment from the heat radiation of exhaust gas guiding tube 30. It can be seen that connecting portion 16 of vaporizer 10 extends through heat shield 32. This allows to electrically connect the heating element at a place where the maximum temperatures are moderate, namely behind the heat shield.

As can be seen in FIG. 2, vapor outlet 22 of housing 18 is provided with a vapor tube 34 which extends into exhaust gas guiding tube 30. Vapor tube 34 guides the fuel vapor generated in vaporizing chamber 12 from the heating element into the exhaust gas. In order to introduce the vaporized fuel into the exhaust gas, an outlet hole 36 is provided at the end of vapor tube 34. If necessary, additional elements for improving the uniform distribution of the fuel vapor in the exhaust gas can be used. It is to be noted that outlet hole 36 must not be arranged at the end of vapor tube 34. Furthermore, vapor tube 34 could be provided with an open end such that no outlet hole at all is necessary.

As can be further seen in FIG. 2, a reactant tube 38 is provided which is connected to fluid inlet 20 of housing 18. Reactant tube 38 is formed from metal and also extends through heat shield 32. This allows, in view of the moderate temperatures existing behind the heat shield, to connect to reactant tube 38 a conventional, flexible fuel pipe.

It can be seen in FIG. 2 that the length of connection portion 16 is longer than in conventional glow plugs. In particular, the length of connection portion 16 is approximately the same as of housing 18. This allows the connection portion to extend through the heat shield so that its free end is “behind” the heat shield. As can be further seen in FIG. 2, the longitudinal axis A of the heating element is arranged generally in a vertical direction. Depending on the space available within the motor compartment, the heating element could also be arranged with a certain inclination with respect to the vertical direction, e.g. up to 45°. This does not affect the transformation of the fuel from liquid form into vapor.

1. Vaporizer (10), in particular for an exhaust gas system of a combustion engine, having a heating element (14, 16) with a heating portion (14) and a connection portion (16), and a vaporizing chamber (12) in which the heating portion (14) of the heating element is arranged, the vaporizing chamber having a fluid inlet (20) and a vapor outlet (22), the vapor outlet (22) being arranged in the vicinity of the junction between the heating portion (14) and the connection portion (16) whereas the fluid inlet (20) is arranged in the vicinity of the free end of the heating portion (14).

2. The vaporizer according to claim 1 wherein the vapor outlet (22) of the vaporizing chamber (12) communicates with a vapor tube (34) which extends at an angle between about 45° and 90° with respect to the longitudinal axis (A) of the heating element (14, 16).

3. The vaporizer according to claim 1 wherein the fluid inlet of the vaporizing chamber (12) communicates with a reactant tube (38) which is formed from a heat-resistant material.

4. The vaporizer according to claim 1 wherein the length of the connection portion (16) is approximately the same as the length of the heating portion (14).

5. The vaporizer according to claim 1 wherein the heating element (14, 16) is a glow plug.

6. A unit comprising an exhaust gas guiding tube (30), a vaporizer (10) having a heating element (14, 16) with a heating portion (14) and a connection portion (16), and a vaporizing chamber (12) in which the heating portion (14) of the heating element is arranged, the vaporizing chamber having a fluid inlet (20) and a vapor outlet (22), the vapor outlet (22) being arranged in the vicinity of the junction between the heating portion (14) and the connection portion (16) whereas the fluid inlet (20) is arranged in the vicinity of the free end of the heating portion (14)and having a vapor tube (34), the vaporizer (10) extending with its connection portion (16) to a cooler area and with its vapor tube (34) into the exhaust gas guiding tube (30).

7. The unit according to claim 6 wherein a heat shield (32) is provided through which the connection portion (16) of the vaporizer (10) extends.

8. The unit according to claim 6 wherein the vaporizer has a reactant tube (38) which extends through the heat shield (32).

9. The unit according to claim 6 wherein the longitudinal axis (A) of the heating element (14, 16) is arranged generally in a vertical direction, with the free end of the heating portion (14) being below the connection portion (16).
